(19) United States
(12) Patent Application Publication
(10) Pub. No.: US 2003/0041122 A1
(43) Pub. Date: Feb. 27, 2003

(54) Method and apparatus for transmitting, receiving, and executing an application query messages via an internet protocol transport

(76) Inventor: Niranjan Nath Segal, Arlington, TX (US)

Correspondence Address: MOTOROLA, INC., 1303 EAST ALGONQUIN ROAD, IL01/3RD, SCHAUMBURG, IL, 60196

(21) Appl. No.: 10/161,533

(22) Filed: Jun. 3, 2002

Related U.S. Application Data
(60) Provisional application No. 60/314,322, filed on Aug. 23, 2001.

(51) Int. Cl. G06F 15/16

(52) U.S. Cl. 709/219

(57) ABSTRACT

A method and apparatus for transmitting and receiving SS7 user adaptation messages (301) is provided herein. In accordance with the preferred embodiment of the present invention, an SS7 application proxy function (105) is provided that receives particular SS7 User Adaptation Messages (301) within an IP packet (300), determines the type of application requested, and forwards these messages to an appropriate application (106). Because standard SS7 messages (301) are transmitted via an IP transport, the transport advantages if IP are combined with the existing applications/services provided by SS7.

### FIELD OF THE INVENTION

The present invention relates generally to communication systems and in particular, to a method and apparatus for transmitting, receiving, and executing application query messages via an internet protocol transport.

### BACKGROUND OF THE INVENTION

Existing signaling system seven (SS7) messages are transported exclusively over the public-switched telephone networks (PSTNs) using standard transport protocols (e.g., MTP3/2/1) and T1/E1 lines. Over the years, SS7 has developed a large amount of applications and services that are now considered inherent in any telephone system. For example, caller identification, call forwarding, call roaming, . . . , etc. have all been developed and are vastly utilized by SS7.

Recently, however, more and more networks are moving towards an Internet Protocol (IP) based transport. The move to an IP-based transport provides flexibility and less cost, but will not be without a host of new problems, including how to maintain existing SS7 services and applications over the IP-based network. Therefore a need exists for a method and apparatus for transmitting, receiving, and executing an SS7 application and query messages via an IP-based network transport.

### BRIEF DESCRIPTION OF THE DRAWINGS

FIG. 1 is a block diagram of a communication system in accordance with a the preferred embodiment of the present invention.

FIG. 2 is a flow chart showing operation of the communication system of FIG. 1 in accordance with the preferred embodiment of the present invention.

FIG. 3 illustrates an IP packet containing SS7 information in accordance with the preferred embodiment of the present invention.

FIG. 4 is a block diagram of the SS7/IP user Application Proxy (SAP) in accordance with the preferred embodiment of the present invention.

FIG. 5 is a flow chart showing operation of the SAP of FIG. 4 in accordance with the preferred embodiment of the present invention.

### DETAILED DESCRIPTION OF THE DRAWINGS

To address the above-mentioned need, a method and apparatus for transmitting, receiving, and executing SS7 User Adaptation messages is provided herein, In accordance with the preferred embodiment of the present invention, an SS7 application proxy function is provided that receives particular SS7 User Adaptation Messages within an IP packet, determines the type of application requested, and forwards these messages to an appropriate application. Because standard SS7 messages are transmitted via an IP transport, the transport advantages if IP are combined with the existing applications/services provided by SS7.

The present invention encompasses a method for receiving and executing an application query message via an IP transport. The method comprising the steps of receiving an IP packet, extracting an SS7 user adaptation message from the IP packet, and determining an appropriate user application from the SUA message. An appropriate address for execution of the user application is determined and the SUA message is re-encapsulated within a second IP packet. Finally the second IP packet with the SUA message is forwarded to the appropriate address for execution of the user application.

The present invention additionally encompasses a method for receiving and executing an application query message via an IP transport. The method comprising the steps of receiving an IP packet, extracting an SS7 user adaptation message from the IP packet, and determining an appropriate user application from the SUA message. In the preferred embodiment of the present invention the user application is chosen from the group consisting of user authentication, caller identification, call forwarding, and call roaming. An appropriate address for execution of the user application is determined and the SUA message is encapsulated within a second IP packet. Finally the second IP packet with the SUA message is forwarded to the appropriate address for execution of the user application.

Finally, the present invention encompasses an apparatus for receiving and executing an application query message via an internet protocol transport. The apparatus comprises logic circuitry having a first IP packet as an input and a second IP packet as an output, wherein the first IP packet comprises an SS7 User Adaptation (SUA) message and a first IP address, and the second IP packet comprises the SS7 User Adaptation message and a second IP address. An SS7 application database is provided, coupled to the logic circuitry, the SS7 application database providing the logic circuitry with the second IP address.

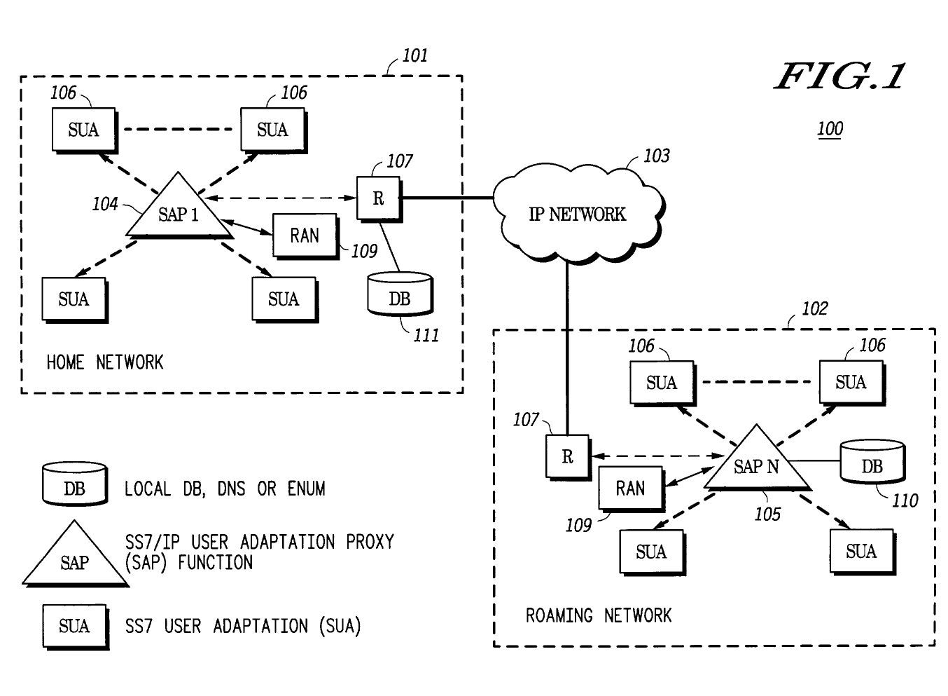

Turning now to the drawings, wherein like numerals designate like components, FIG. 1 is a block diagram of communication system 100 in accordance with a the preferred embodiment of the present invention. As shown, communication system 100 comprises home network 101, roaming network 102, and an intervening IP network 103. In the preferred embodiment of the present invention both home and roaming networks 101 and 102 comprise radio access networks (RANs) 109 and SS7 user Adaptation Proxy functions (SAPs) 104 and 105. Networks 101 and 102 also comprise a plurality of SS7 user adaptations 106, router 107, and database/DNS lookup 110.

In the preferred embodiment of the present invention SAPs 104 and 105 serve as proxy servers that forward particular messages to another system in response to a request to do so. More particularly SAPs are logical entities used to front end all the SS7 user adaptation (SUA) service nodes for the incoming SUA messages either from the IP network or from the SS7 network via a signaling gateway, utilizing the Stream Control Transmission Protocol (SCTP) association with the Application Server Process/Signaling Gateway Process (ASP/SGP).

RANs 109 are preferably cellular communication systems that utilize a communication protocol such as, but not limited to, a Code Division Multiple Access (CDMA) system protocol, the Narrowband Advanced Mobile Phone Service (NAMPS) protocol, the Advanced Mobile Phone Service (AMPS) protocol, the Global System for Mobile Communications (GSM) protocol, General Packet Radio System (GPRS), the Personal Digital Cellular (PDC) protocol, or the United States Digital Cellular (USDC) protocol.

During operation, SAPs 104 and 105 receive standard SS7 user adaptation (SUA) messages encapsulated within IP packets. As one of ordinary skill in the art would recognize, SUA messages comprise SCCP User Data as defined by the Internet Engineering Task Force (IETF) in draft-IETF-sigtran-SUA-07.txt. In the preferred embodiment of the present invention SAPs 104 and 105 extract the SUA messages from the IP packets and determine the type of service or application requested. In the preferred embodiment of the present invention each SUA 106 serves to provide an SS7 service/application. Once the service or application has been determined by the SAP, the SAP then forwards the SUA message to the appropriate application (SUA) 106 for execution.

For example, RAN 109 may provide SAP 105 with a standard SS7 request for authentication. The standard authentication message is encapsulated within an IP packet and transmitted, to SAP 105. Once received, SAP 105 examines the SUA message, which in this case is an SS7 authentication message, and determines the type of message received. Once the type of message is determined, an appropriate SUA 106 is determined. The SS7 message is passed to that particular SUA 106. Depending upon what type of SS7 message has been forwarded to SUA 106, SAP 105 may receive a response from SUA 106 that is passed on to the particular service/application requester.

Because standard SS7 messages transmitted via an IP transport can be utilized by SAP 105, the communication system described above combines the transport advantages if IP with the existing applications/services provided by SS7.

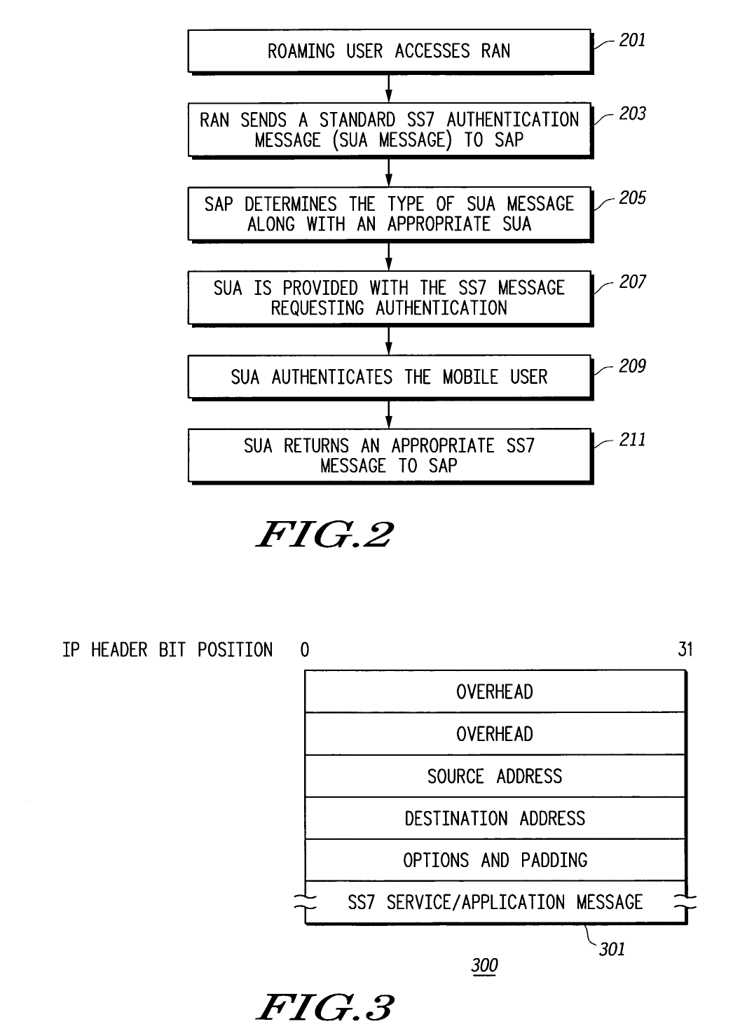

FIG. 2 is a flow chart showing operation of communication system 100 of FIG. 1 in accordance with the preferred embodiment of the present invention. Although communication system 100 is capable of processing all SS7 services/applications, the description that follows illustrates operation of communication system 100 during a user authentication.

The logic flow begins at step 201 where a roaming user (not shown) accesses RAN 109. As part of accessing a RAN, the RAN is provided with a mobile station identifier (typically an International Mobile Station Identification (IMSI)). RAN 109 then sends a standard SS7 authentication message (SUA message) to SAP 105 (step 203). As described above, the authentication message is encapsulated in an IP packet and transmitted via an IP protocol to SAP 105. Once the message has been received by SAP 105, SAP 105 determines the type of SUA message along with an appropriate SUA 106 (step 205). Once an appropriate SUA 106 has been determined (in this case a SUA that performs authentication) by SAP 105, the SUA is provided with the SS7 message requesting authentication (step 207). As described above, SUA 106 serves to execute a particular SS7 application/service, and in this example, SUA 106 authenticates the mobile user (step 209), and returns an appropriate SS7 message to SAP 105 either authenticating or denying the roaming user (step 211). This message is then passed to the requesting RAN 109.

During authentication (step 209), SUA 106 actually executes a series of steps that are required for authentication purposes. More particularly, from the IMSI, SUA 106 determines a country code, area code, and exchange code for the roaming user's home network. Once the user's home network is determined, a particular user's node on that network needs to be determined so the node can be queried whether the user is a valid user or not. To accomplish this, SUA 106 accesses a local Domain Name Server (DNS) 111 via network 103, and provides the server with a translated IMSI called E.214 number (CC+NPA+Exchange Code) via a DNS query. Local DNS server 111 determines an IP address for SAP 104 existing on the user's home network. The IP address for SAP 104 in the home network is then provided to SUA 106 on the roaming network via the response to the DNS query. After receiving this IP address for the SAP, SUA 106 sends an SS7 SUA authentication message to SAP 104 using this IP address. SAP 104 forwards the authentication message to an appropriate SUA 106 on the home network, and SUA 106 on the home network returns an authorization message to SUA 106 on the roaming network.

As discussed above, the preceding discussion was limited to user authentication, however, in accordance with the preferred embodiment of the present invention any SS7 application/service may be performed via the above technique.

FIG. 3 illustrates IP packet 300 containing SS7 information in accordance with the preferred embodiment of the present invention. As shown, IP packet 300 comprises overhead information, source address, destination address, options and padding, and an SS7 service/application (SUA) message 301. As one of ordinary skill in the art would recognize, overhead information for the IP packet comprises information such as IP version, total packet length, time to live, header checksum, . . . , etc. Additionally, as discussed above, SUA message comprises Signaling Connection and Control Protocol (SCCP) data as described in ITU specification Q.713.

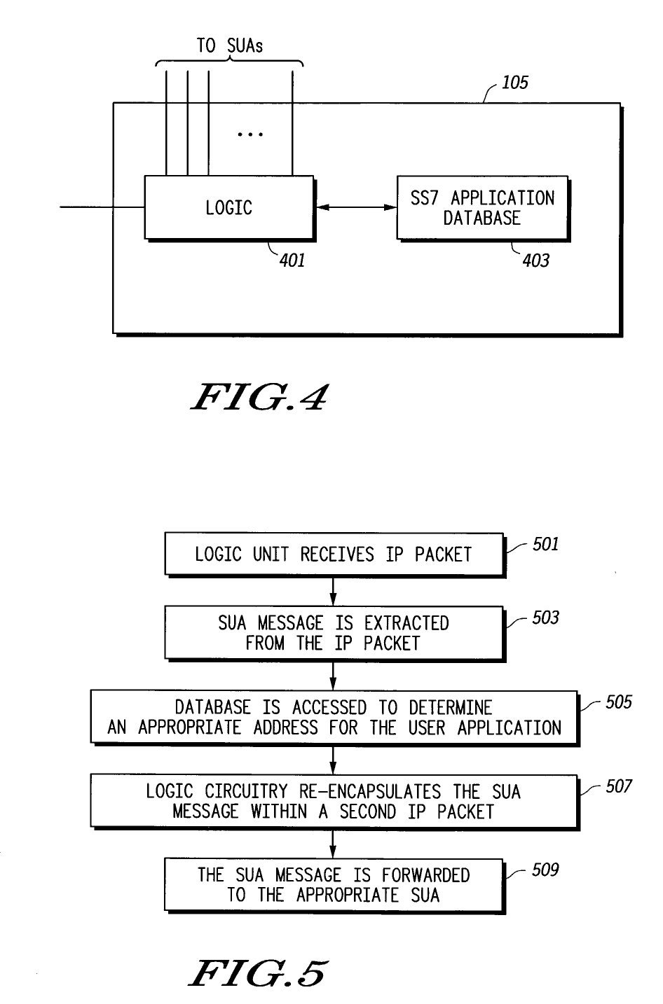

FIG. 4 is a block diagram of the SS7/IP User Application Proxy (SAP) in accordance with the preferred embodiment of the present invention. As shown, SAP 105 comprises logic circuitry 401 and an SS7 Application database 403. In the preferred embodiment of the present invention logic circuitry 401 accesses database 403 to determine where to route a received SUA message. More particularly, logic unit 401 receives a first IP packet 300 having a first address. Logic circuitry 401 then retrieves the particular SUA message 201 encapsulated within IP packet 300. Once SUA message 301 has been determined, database 403 is accessed to determine a second IP address of the appropriate SUA. SUA message 301 is re-encapsulated in a new IP packet and transmitted to the appropriate SUA.

FIG. 5 is a flow chart showing operation of SAP 105 of FIG. 4 in accordance with the preferred embodiment of the present invention. The logic flow begins at step 501 where logic unit 401 receives IP packet 300. As discussed above, IP packet 300 comprises standard SS7 user adaptation message 301 as shown in FIG. 3. Once received, SUA message 301 is extracted from the IP packet 300 at step 503. At step 505 a user application is determined and database 403 is accessed to determine an appropriate address for the user application. As discussed above, networks 101 and 102 comprise multiple SUAs 106, each capable of executing a particular SS7 service/application. Because of this, logic circuitry 401 needs to determine a particular SUA 106 for routing SUA message 301. This information is returned from database 403.

Continuing, at step 507 logic circuitry 401 re-encapsulates SUA message 301 within a second IP packet. In the preferred embodiment of the present invention the second IP packet contains the address of the SUA that will execute the application requested within the SUA message. Finally, at step 509, the SUA message is forwarded to the appropriate SUA 106.

It should be noted that in addition to forwarding SUA message 301 to the appropriate SUA 106, logic unit may also receive information back from SUA 106. For example, in situations where the execution of a particular SS7 application results in information returned, this information will be retuned to SUA 106 for further processing. For instance, as discussed above, an SS7 authentication message results in the return of specific information (e.g., whether the user is a valid user). After logic unit 401 forwards the authentication message to the appropriate SUA 106, SUA 106 will execute the application and provide logic unit 401 with an appropriate answer.

While the invention has been particularly shown and described with reference to a particular embodiment, it will be understood by those skilled in the art that various changes in form and details may be made therein without departing from the spirit and scope of the invention. For example, It is intended that such changes come within the scope of the following claims.

1. A method for receiving and executing an application query message via an internet protocol transport, the method comprising the steps of:
receiving an Internet Protocol (IP) packet;
extracting an SS7 user adaptation (SUA) message from the IP packet;
determining an appropriate user application from the SUA message;
determining an appropriate address for execution of the user application;
re-encapsulating the SUA message within a second IP packet; and
forwarding the SUA message to the appropriate address for execution of the user application.

2. The method of claim 1 wherein the step of determining the appropriate user application from the SUA message comprises the step of determining the appropriate user application, wherein the user application is chosen from the group consisting of user authentication, caller identification, call forwarding, and call roaming.

3. The method of claim 1 wherein the step of determining the appropriate address for execution of the user application comprises the step of determining an appropriate IP address for execution of the user application.

4. A method for receiving and executing an application query message via an Internet Protocol (IP) transport, the method comprising the steps of:
receiving an IP packet;
extracting an SS7 User Adaptation (SUA) message from the IP packet;
determining an appropriate user application from the SUA message, wherein the step of determining the appropriate user application from the SUA message comprises the step of determining the appropriate user application, wherein the user application is chosen from the group consisting of user authentication, caller identification, call forwarding, and call roaming;
determining an appropriate IP address for execution of the user application;
re-encapsulating the SUA message within a second IP packet; and
forwarding the SUA message to the appropriate address for execution of the user application.

5. An apparatus for receiving and executing an application query message via an internet protocol transport, the apparatus comprising:
logic circuitry having a first IP packet as an input and a second IP packet as an output, wherein the first IP packet comprises an SS7 User Adaptation (SUA) message and a first IP address, and the second IP packet comprises the SS7 User Adaptation message and a second IP address; and
an SS7 application database coupled to the logic circuitry, the SS7 application database providing the logic circuitry with the second IP address.

6. The apparatus of claim 5 wherein the second IP address comprises an IP address of a User Adaptation Protocol (SAP) utilized to execute an application defined by the (SUA).
